(19) United States
(12) Patent Application Publication
(10) Pub. No.: US 2016/0034852 A1
(43) Pub. Date: Feb. 4, 2016

(54) NEXT JOB SKILLS AS REPRESENTED IN PROFILE DATA

(71) Applicant: LinkedIn Corporation, Mountain View, CA (US)

(72) Inventors: Navneet Kapur, Sunnyvale, CA (US); Christina Allen, Palo Alto, CA (US); Ada Cheuk Ying Yu, Santa Clara, CA (US)

(21) Appl. No.: 14/448,066

(22) Filed: Jul. 31, 2014

(51) Int. Cl. G06Q 10/10

(52) U.S. Cl. CPC G06Q 10/1053; G06Q 50/01

(57) ABSTRACT

A machine may be configured to identify skills for a projected next job position. For example, the machine performs an analysis of profile data associated with a plurality of members of a social network service. Based on the analysis of the profile data and a present job position of a particular member of the social network service, the machine identifies a projected next position in a career path model. The machine identifies a cohort of other members of the social network service. The identifying of the cohort may be based on each cohort member holding the projected next position in a respective career. Each cohort member may be associated with one or more skills. The machine identifies one or more over-indexed skills for the cohort based on the one or more skills of the cohort members. The machine generates a recommendation that includes the one or more over-indexed skills.

### TECHNICAL FIELD

The present application relates generally to the processing of data, and, in various example embodiments, to systems and methods for identifying and recommending skills for a projected next job position.

### BACKGROUND

It is not uncommon for a person to transition to a new job every few years as the person progresses through a career. The new job may utilize the person's current skills or may require new skills. The skills a person should have in a desired job position may sometimes be difficult to ascertain without discussing the respective job position with an employee who currently holds such a job position.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a skill identification system, according to some example embodiments;

FIG. 3 is a flowchart illustrating a method of identifying skills for a projected next job position, according to some example embodiments;

FIG. 4 is a flowchart that illustrates a method of identifying skills for a projected next job position and represents the step 310 of FIG. 3 in more detail, according to some example embodiments;

FIG. 5 is a flowchart that illustrates a method of identifying skills for a projected next job position and represents one or more additional steps of FIG. 3, according to some example embodiments;

FIG. 6 is a flowchart that illustrates a method of identifying skills for a projected next job position and represents the step 320 of FIG. 3 in more detail, according to some example embodiments;

FIG. 7 is a flowchart that illustrates a method of identifying skills for a projected next job position and represents the step 350 of FIG. 3 in more detail and an additional step of FIG. 3, according to some example embodiments;

FIG. 8 is a flowchart that illustrates a method of identifying skills for a projected next job position and represents the step 340 of FIG. 3 in more detail, according to some example embodiments;

FIG. 9 is a flowchart that illustrates a method of identifying skills for a projected next job position and represents an additional step of FIG. 3, according to some example embodiments;

FIG. 10 is a flowchart that illustrates a method of identifying skills for a projected next job position and represents the step 350 of FIG. 3 in more detail, according to some example embodiments;

FIG. 11 is a block diagram illustrating a mobile device, according to some example embodiments; and

FIG. 12 is a block diagram illustrating components of a machine, according to some example embodiments, able to read instructions from a machine-readable medium and perform any one or more of the methodologies discussed herein.

### DETAILED DESCRIPTION

Example methods and systems for identifying skills for a projected next job position are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

In some example embodiments, a skill identification system performs an analysis of profile data available to a social network service (e.g., member profile data associated with a plurality of members of a social network service, such as LinkedIn®) and identifies one or more career paths. A career path may be conceptualized as a sequence of job positions in time. The job positions may be characterized by a number of attributes, such as title, industry, company, duration, seniority, pay level, etc. Although different members of the social network service may have unique, personal career paths, trends may be identified (e.g., by the skills identification system) that indicate likely career transitions between certain job positions. In various example embodiments, the skill identification system may generate career path models whose sequences of positions indicate highly likely transitions between job positions. The career path models may be generated based on the analysis of a large body of profile data, including job positions held by members of the social network service, maintained by a social networking system.

Based on the analysis of the profile data (e.g., one or more career paths), the skill identification system may project (e.g., predict) that a particular member of the social network service is likely to be interested in one or more potential next job positions based on the present job position of the particular member. The present career position of the particular member and a projected next position may be sequential (e.g., consecutive) job positions included in a particular career path model.

According to certain example embodiments, the skill identification system may identify one or more projected next job positions for a particular member of a social networking system based on the present job position of the particular member and one or more career path models. For example, if the present job title of a particular member is Software Engineer, one possible projected (e.g., future or aspirational) job title for a Software Engineer based on a first potential career path is Director of Engineering. Another possible projected job title for a Software Engineer based on a second potential career path is Project Manager.

The skill identification system may identify a target cohort (also “cohort”) of other members of the social network service who are in job positions that are the same as the projected next position for the particular user. The cohort members may have a variety of skills. The skills characterize the knowledge, abilities, experiences, etc. of the cohort members and may be employment-related skills. The skills are associated with respective cohort members and, in some instances, may be identified (e.g., by the skill identification system) based on the member profiles of the respective cohort members or other data associated with the cohort members.

In some example embodiments, the skill identification system may identify one or more over-indexed skills for the cohort based on the one or more skills of the cohort members. An over-indexed skill may be a skill common to the members of a particular cohort but also relatively unique to the particular cohort as compared to the skills of the members of another cohort. The use of an over-indexing methodology may facilitate the identification of a skill that is popular within a particular cohort without being common across different cohorts. An example of a skill that may be common within a particular cohort and across numerous cohorts is the knowledge of Microsoft® Word®. Such a skill may be weeded out by the skill identification system based on the respective skill being shared by members of different cohorts.

In certain example embodiments, the identification of an over-indexed skill (e.g., a skill shared by a majority of the members of a cohort but not common across different cohorts) may be performed based on computing the number of standard deviations from the mean for different skills distributions in different cohorts. The resulting numbers of deviations for a skill may be compared for different cohorts in order to identify the skills on which a particular cohort over-indexes. For example, the probability of cohort A having skill X is 0.5 and the average probability of all cohorts having the skill X is 0.1 (e.g., with standard deviation of 0.04). Based on comparing the probability of cohort A to the average probability of all cohorts for the skill X, the skill identification system may determine that cohort A over-indexes on the skill X.

The analysis of the profile data, the identification of a projected next job position, the identification of the target cohort, the identification of the over-indexed skills, or a suitable combination thereof, may be performed by the skill identification system in real time in response to a request for skills a person should have in a job position or at predetermined times. For example, the skill identification system may periodically (e.g., once a week or twice a month) run one or more batch process jobs to perform one or more of the above-described functions of the skill identification system. The obtained results (e.g., identifiers of one or more over-indexed skills associated with the respective cohort and with the projected next job position) may be stored in a record of a database for further use. One such further use may be communicating the one or more over-indexed skills to a particular member whose present job position may be mapped to the projected next job position associated with the one or more over-indexed skills.

The skill identification system may, in some example embodiments, generate a recommendation that includes the one or more over-indexed skills. The recommendation may be communicated to the particular user in association with a corresponding projected next job position (e.g., title, description, etc.) via a user interface of a client device. In various embodiments, the recommendation includes (e.g., lists) descriptions of courses that teach the over-indexed skills or facilitates registration for such courses, or both. In certain example embodiments, the recommendation presents social proof that the one or more over-indexed skills are valuable (e.g., by displaying profiles of members having the projected next job position or profiles of successful people who have the one or more over-indexed skills). In some example embodiments, the recommendation displays descriptions of jobs requiring the one or more over-indexed skills.

In some instances, the skill identification system may determine, for example, based on profile data, whether a particular member for whom a projected next position has been identified already possesses the over-indexed skill of the target cohort. The skill identification system may generate the recommendation of the over-indexed skill upon determining that the particular member does not possess the over-indexed skill.

According to various example embodiments, the skill identification system generates the recommendation of the over-indexed skills in response to a request received by the skill identification system. In some instances, the request may be issued by the particular member of the social network service when utilizing one or more services of the social networking system. In some instances, the request for a recommendation of the over-indexed skills may be issued by a component of the social networking system upon authenticating the particular member as being logged into the social networking system.

The identification of one or more projected next job positions, the identification of over-indexed skills for one or more cohorts of members in the projected next job positions, and the recommendation of the over-indexed skills to a particular member may facilitate a timely acquiring of the over-indexed skills by the particular member. In addition to the particular member benefitting from the insights provided with respect to the over-indexed skills, the social network service and employers may benefit from a larger pool of candidates for the projected next job positions who possess the over-indexed skills.

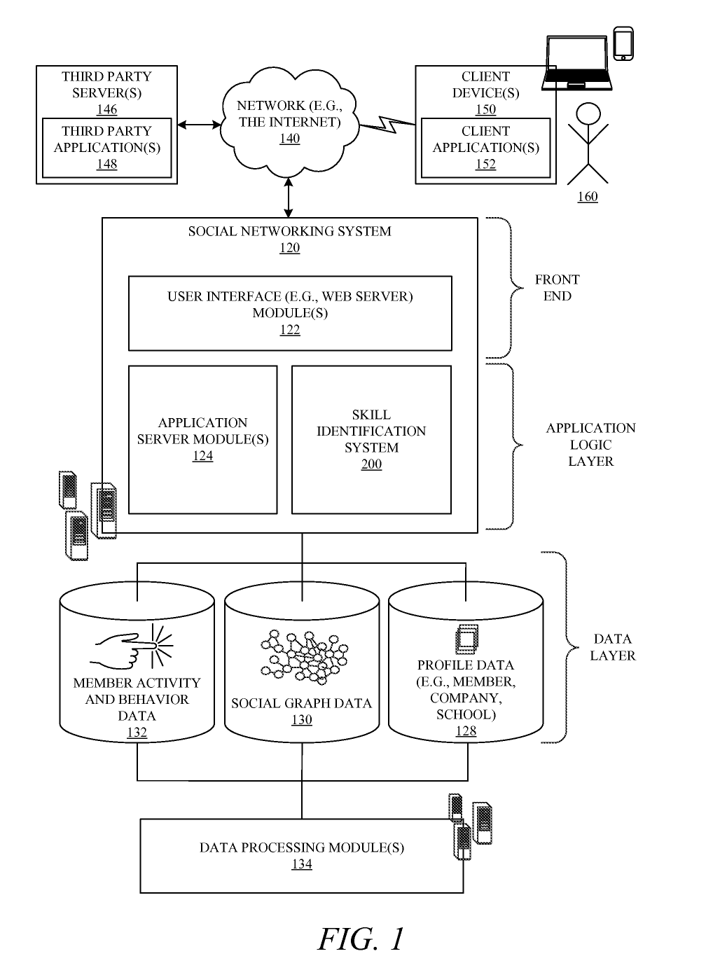

An example method and system for identifying skills for a projected next job position may be implemented in the context of the client-server system illustrated in FIG. 1. As illustrated in FIG. 1, the skill identification system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social network service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social network service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the skill identification system 200, which is described in more detail below.

Further, as shown in FIG. 1, a data processing module 134 may be used with a variety of applications, services, and features of the social networking system 120. The data processing module 134 may periodically access one or more of the databases 128, 130, or 132, process (e.g., execute batch process jobs to analyze or mine) profile data, social graph data, or member activity and behavior data, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

In some example embodiments, the data processing modules 134 may perform an analysis of profile data associated with a plurality of members of the social network service. For example, the data processing module 134 may analyze career progressions (e.g., transitions from one job position to another job position) of the plurality of members based on the profile data and/or may generate one or more career path models based on the analysis of the career progressions of the plurality of members. The results of the analyses performed by the data processing module 134 may be stored for further use, in one of the databases 128, 130, or 132, or in another database.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

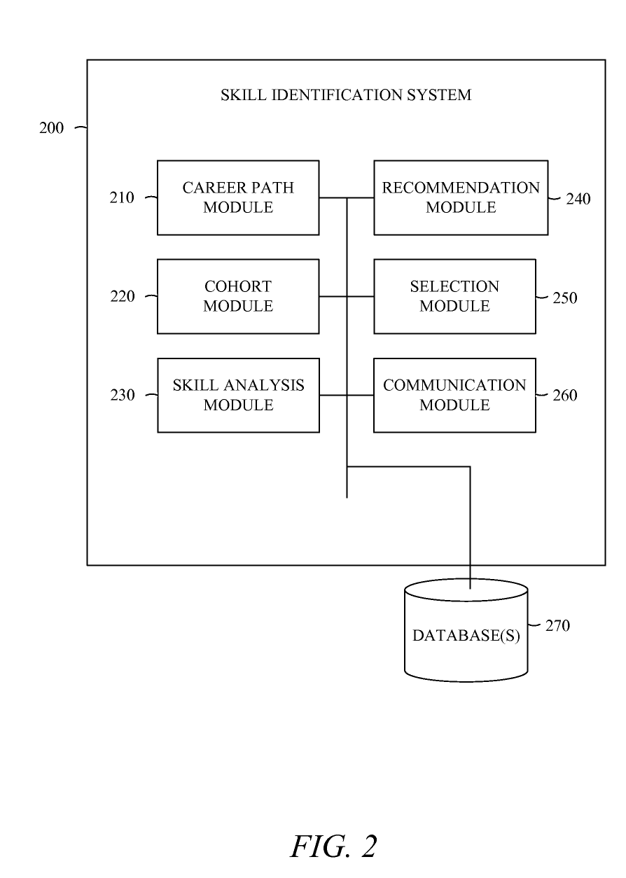

FIG. 2 is a block diagram illustrating components of the skill identification system 200, according to some example embodiments. As shown in FIG. 2, the skill identification system 200 may include a career path module 210, a cohort module 220, a skill analysis module 230, a recommendation module 240, a selection module 250, and a communication module 260, all configured to communicate with each other (e.g., via a bus, shared memory, or a switch).

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 270 (e.g., the database 128, the database 130, or the database 132).

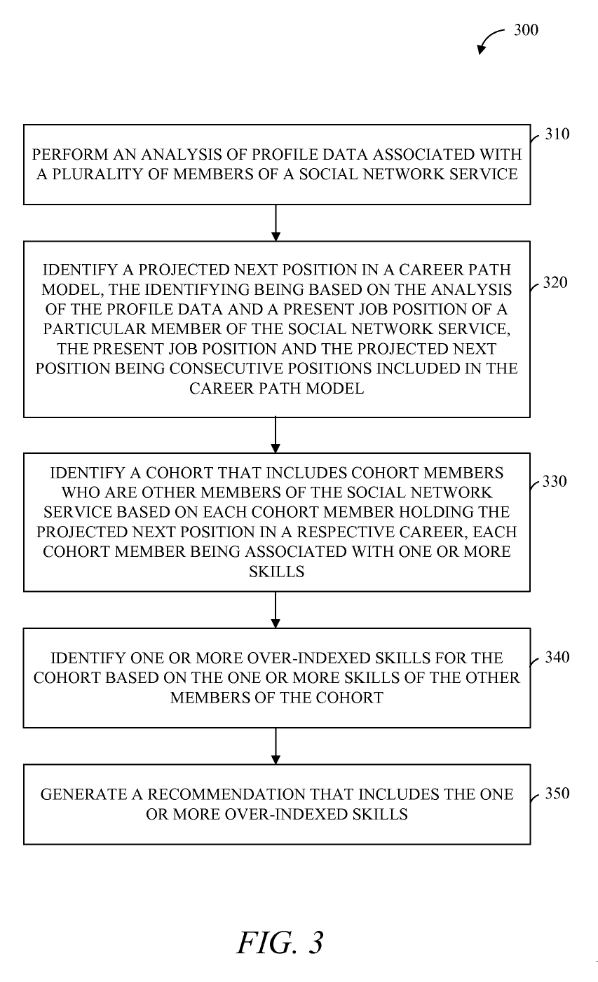

FIGS. 3-11 are flowcharts illustrating a method of identifying skills for a projected next job position, according to some example embodiments. Operations in the method 300 may be performed using modules described above with respect to FIG. 2. As shown in FIG. 3, the method 300 may include one or more of operations 310, 320, 330, 340, and 350.

At method operation 310, the career path module 210 performs an analysis of profile data associated with a plurality of members of a social network service. The plurality of members whose profile data is analyzed may be selected based on a variety of criteria (e.g., characteristics, attributes, or identifiers) associated with the members of the social network service, for example, when the members join the social network service or provide profile data about themselves. Examples of such criteria are a user identifier (ID), an industry of employment, an employer, a geographical area, etc.

In some example embodiments, the career path module 210 provides a variety of standardization functionality. For example, the career path module 210 may standardize a variety of attributes, characteristics, or other information. Standardization (also referred to as canonicalization), as used herein, is intended to include generating and/or determining a standardized form of an attribute, characteristic, or other information. For instance, a particular attribute, characteristic, or piece of information may be similar or intended to be similar to another attribute characteristic or piece of information. In this instance, standardizing the information may result in generating a standard form (also referred to as normal form) that reduces a variety of similar representations of the information to a standardized form. For a specific example, various pieces of information may be referring to a single street name (e.g., “market street,” “Market st.,” or “Market ST”). Standardizing the street name may result in standardized form (e.g., “Market St.”) that may represent multiple similar forms. Standardizing a set of attributes, characteristics, or other information may provide for direct comparisons between standardized forms of information and allow for more accurate mathematical analysis as similar information or information that is intended to be similar may be grouped together. Standardization may be performed using a variety of schemes and techniques.

At method operation 320, the career path module 210 identifies a projected next position in a career path model. The career path model may be generated based on the analysis of the profile data associated with the plurality of members of a social network service. The projected next position may be identified based on the analysis of the profile data (e.g., a result of the analysis of the profile data such as a career path model) and a present career position of a particular member of the social network service.

The career path model may be a representation of a particular sequence of job positions held by a number (e.g., a majority or a large minority) of the plurality of members, generated as a result of the analysis of the profile data of the plurality of members. The career path model may indicate likely transitions from one job position to a next job position. For example, for 40% of the plurality of members who previously held the position of Senior Software Engineer, the next job position was Director of Engineering. According to another example, 37% of the plurality of members who previously held the position of Senior Software Engineer transitioned to the next job position of Project Manager. A comparison of the present career position of the particular member and the career path model may indicate that the present career position of the particular member and the projected next position are subsequent (e.g., consecutive) positions included in the career path model.

At method operation 330, the cohort module 220 identifies a cohort that includes a plurality of cohort member who are other members of the social network service (e.g., the cohort does not include the particular member). The identifying of the members of the cohort may be based on each member of the cohort holding the projected next position in their respective career. The cohort members may be associated with one or more skills (e.g., skills useful or used in their jobs).

At method operation 340, the skill analysis module 230 identifies one or more over-indexed skills for the cohort based on the one or more skills of the cohort members. At method operation 350, the recommendation module 240 generates a recommendation that includes the one or more over-indexed skills.

In some example embodiments, the career path module 210 may identify more than one projected next positions. In some instances, the career path model is a first alternative career path model, the projected next position is a first projected next position, and the cohort is a first cohort. The career path module 210 may identify a second projected next position in a second alternative career path model based on the present job position of the particular member. The present job position and the second projected next career position in the second alternative career path may be sequential (e.g., consecutive) positions included in the second alternative career path model.

The cohort module 220 may identify a second cohort that includes members of the second cohort who are further members of the social network service. The identifying of the second cohort may be based on each member of the second cohort holding the second projected next position in a respective career. Each member of the second cohort may be associated with one or more further skills.

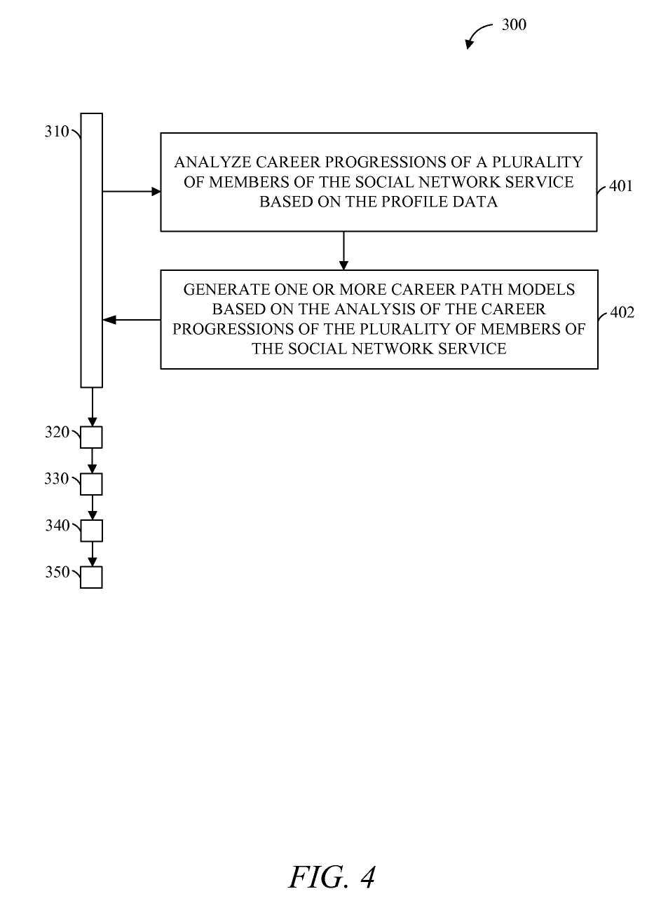

The skill analysis module 230 may identify a number of over-indexed skills for the second cohort based on the one or more further skills of the members of the second cohort. The recommendation module 240 may generate a recommendation that includes the one or more over-indexed skills for the first cohort, as associated with the first projected next position, and the number of over-indexed skills for the second cohort, as associated with the second projected next position. The recommendation may be communicated to the particular member. Further details with respect to the method operations of the method 300 are described below with respect to FIGS. 4-10.

As shown in FIG. 4, the method 300 may include one or more of method operations 401 and 402, according to some example embodiments. Method operation 401 may be performed as part (e.g., a precursor task, a subroutine, or a portion) of method operation 310, in which the career path module 210 performs an analysis of profile data associated with a plurality of members of a social network service.

At method operation 401, the career path module 210 analyzes career progressions of a plurality of members of the social network service based on the profile data (e.g., member profile data associated with the plurality of members). A career progression of a member of the social network service may be indicated by a transition from one job position held by the member to another job position held by the member during the career of the member. The transitions between two job positions may be identified, for example, based on the profile data associated with the member. In some example embodiments, the analyzing of the career progression of a member of the social network service includes identifying and analyzing a transition from one job position held by the member to another job position held by the member.

Method operation 402 may be performed after method operation 401. At method operation 402, the career path module 210 generates one or more career path models based on the analysis of the career progressions of the plurality of members of the social network service.

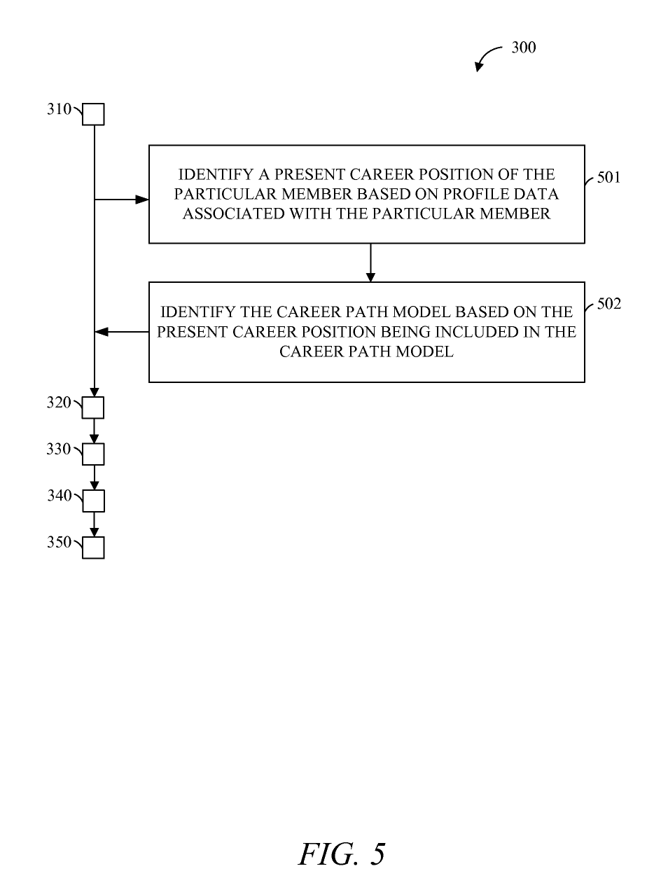

As shown in FIG. 5, the method 300 may include one or more of method operations 501 and 502, according to some example embodiments. Method operation 501 may be performed after method operation 310, in which the career path module 210 performs an analysis of profile data associated with a plurality of members of a social network service, and before method operation 320, in which the career path module 210 identifies a projected next position in a career path model. At method operation 501, the career path module 210 identifies a present career position of the particular member based on profile data associated with the particular member.

Method operation 502 may be performed after method operation 501. At method operation 502, the career path module 210 identifies the career path model based on the present career position being included in the career path model.

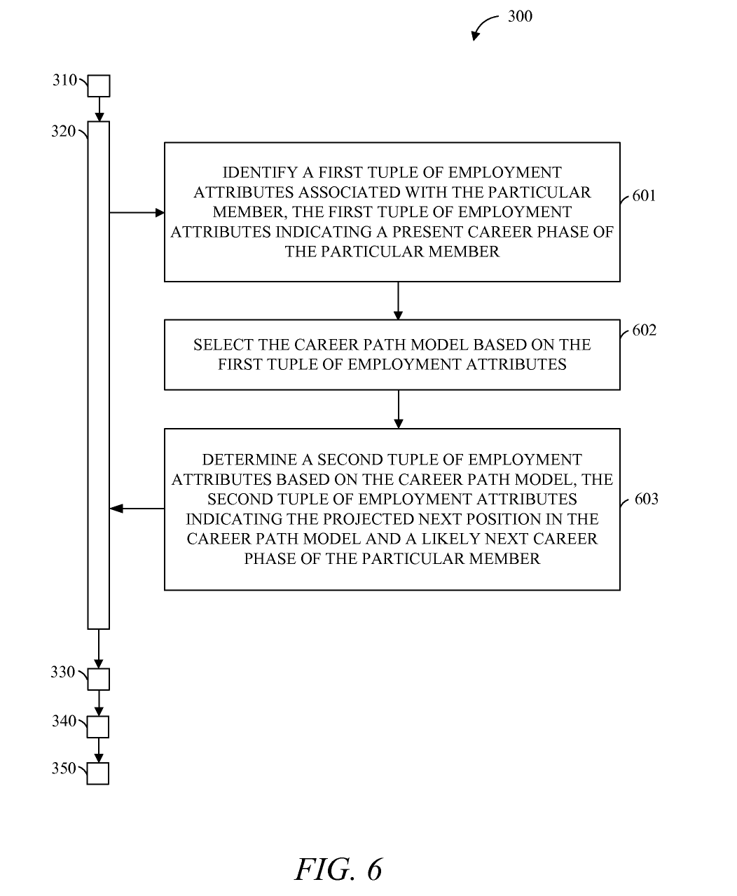

As shown in FIG. 6, the method 300 may include one or more of method operations 601, 602, and 603, according to some example embodiments. Method operation 601 may be performed as part (e.g., a precursor task, a subroutine, or a portion) of method operation 320, in which the career path module 210 identifies a projected next position in a career path model.

At method operation 601, the career path module 210 identifies a first tuple of employment attributes associated with the particular member. The identifying of the first tuple of employment attributes may be based on the profile data associated with the particular member. The first tuple of employment attributes may indicate a present career phase of the particular member. An example of a tuple of employment attributes may include a title-seniority pair, such as (title, seniority), that indicates a present title of the particular member and a present seniority of the particular member. Another example of a tuple of employment attributes may include a title-years of experience pair, such as (title, number of years of experience in a job position), that indicates a present title of the particular member and a number of years of experience of the particular member.

Method operation 602 may be performed after method operation 601 and as part (e.g., a precursor task, a subroutine, or a portion) of method operation 320. At method operation 602, the career path module 210 selects the career path model based on the first tuple of employment attributes. The selection of the career path model may be made from a plurality of previously generated career path models.

Method operation 603 may be performed after method operation 601 and as part (e.g., a precursor task, a subroutine, or a portion) of method operation 320. At method operation 603, the career path module 210 determines a second tuple of employment attributes. The determining of the second tuple of employment attributes may be based on the career path model. The second tuple of employment attributes may indicate the projected next position in the career path model and a likely next career phase of the particular member.

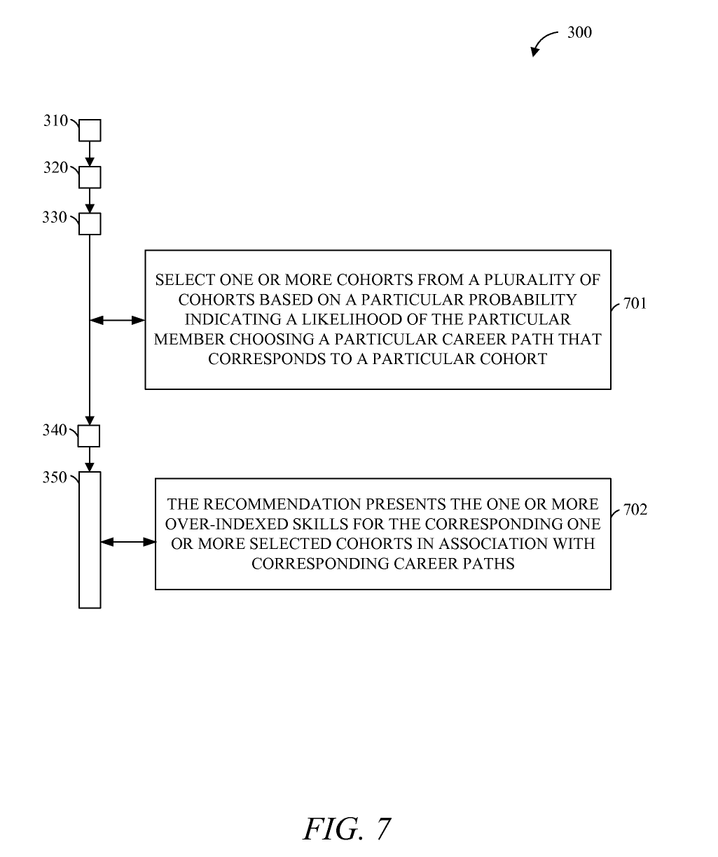

As shown in FIG. 7, the method 300 may include method operations 701 and 702, according to some example embodiments. Method operation 701 may be performed after method operation 330, in which the cohort module 220 identifies a cohort that includes a plurality of cohort member who are other members of the social network service. At method operation 701, the selection module 250 selects one or more cohorts from a plurality of cohorts based on a particular probability indicating a likelihood of the particular member choosing a particular career path (e.g., the projected next job position) that corresponds to a particular cohort.

Method operation 702 may be performed after method operation 701 and as part (e.g., a precursor task, a subroutine, or a portion) of method operation 350, in which the recommendation module 240 generates a recommendation that includes the one or more over-indexed skills. At method operation 702, the recommendation includes (e.g., presents) the one or more over-indexed skills for the corresponding one or more selected cohorts in association with corresponding career paths (e.g., the projected next job position).

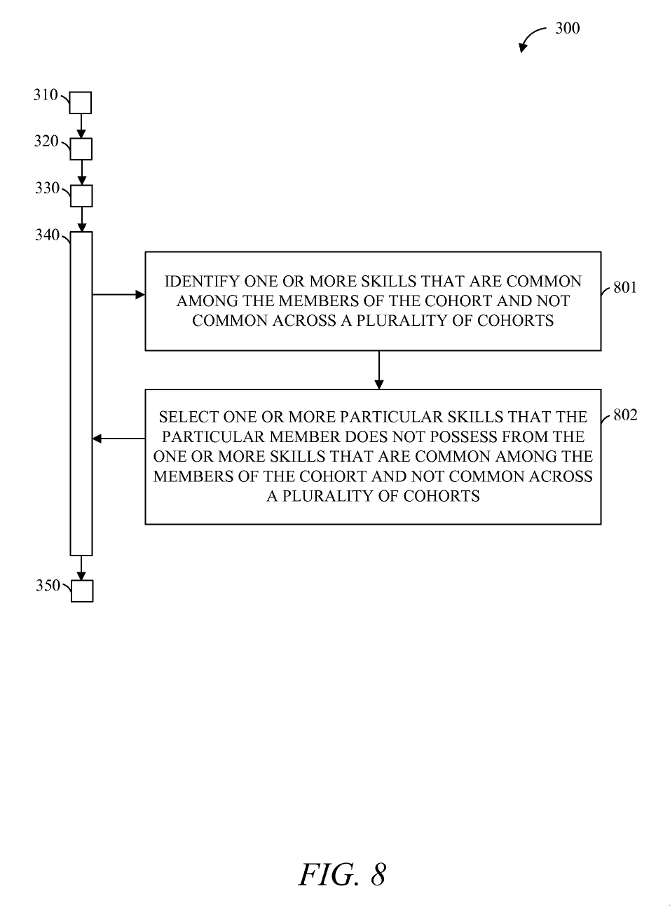

As shown in FIG. 8, the method 300 may include one or more method operations 801 and 802, according to some example embodiments. Method operation 801 may be performed as part (e.g., a precursor task, a subroutine, or a portion) of method operation 340, in which the skill analysis module 230 identifies one or more over-indexed skills for the cohort based on the one or more skills of the cohort members. At method operation 801, the skill analysis module 230 identifies one or more skills that are common among the members of the cohort and not common across a plurality of cohorts.

Method operation 802 may be performed as part (e.g., a precursor task, a subroutine, or a portion) of method operation 340 after method operation 801. At method operation 802, the skill analysis module 230 selects one or more particular skills that the particular member does not possess from the one or more skills that are common among the members of the cohort and not common across a plurality of cohorts.

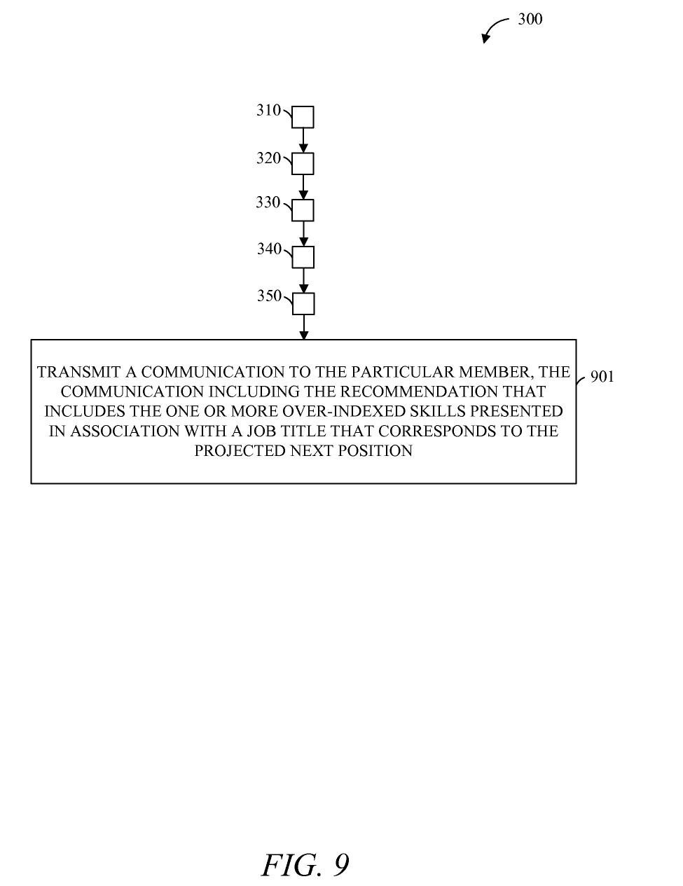

As shown in FIG. 9, the method 300 may include the method operations 901, according to some example embodiments. Method operation 901 may be performed after method operation 350, in which the recommendation module 240 generates a recommendation that includes the one or more over-indexed skills. At method operation 901, the communication module 260 transmits a communication to the particular member. The communication may include the recommendation that includes the one or more over-indexed skills. The recommendation may be presented (e.g., to the particular member) in association with a job title that corresponds to the projected next position in the career path model.

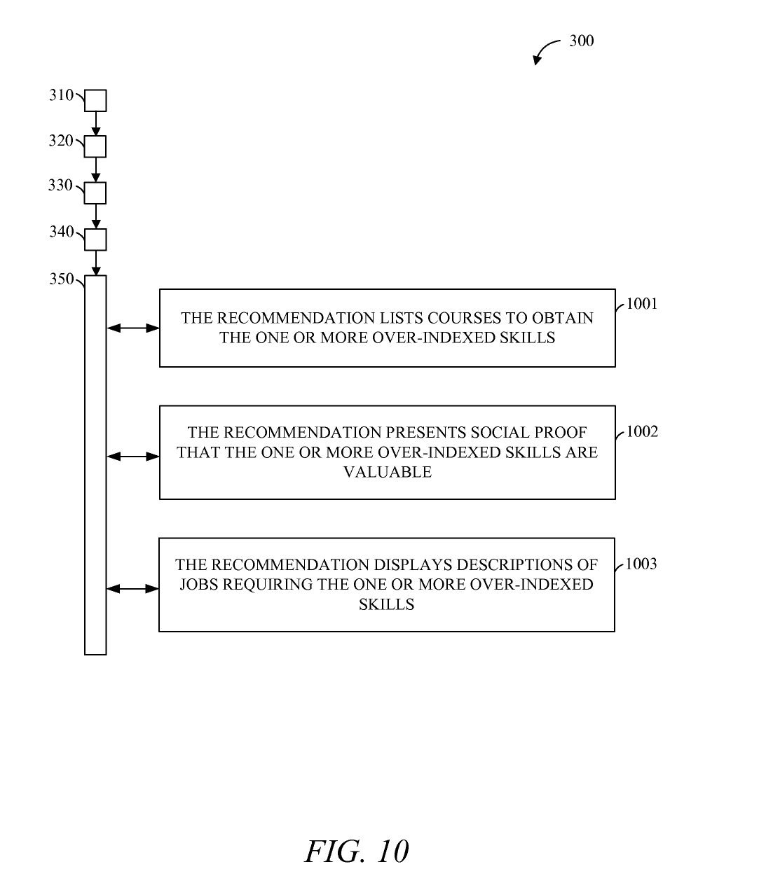

As shown in FIG. 10, the method 300 may include one or more method operations 1001, 1002, and 1003, according to some example embodiments. Method operation 1001 may be performed as part (e.g., a precursor task, a subroutine, or a portion) of method operation 350, in which the recommendation module 240 generates a recommendation that includes the one or more over-indexed skills. At method operation 1001, the recommendation lists courses to obtain the one or more over-indexed skills.

Method operation 1002 may be performed as part (e.g., a precursor task, a subroutine, or a portion) of method operation 350, in which the recommendation module 240 generates a recommendation that includes the one or more over-indexed skills. At method operation 1002, the recommendation presents social proof that the one or more over-indexed skills are valuable (e.g., to the particular member).

Method operation 1003 may be performed as part (e.g., a precursor task, a subroutine, or a portion) of method operation 350, in which the recommendation module 240 generates a recommendation that includes the one or more over-indexed skills. At method operation 1003, the recommendation displays descriptions of jobs requiring the one or more over-indexed skills.

Example Mobile Device

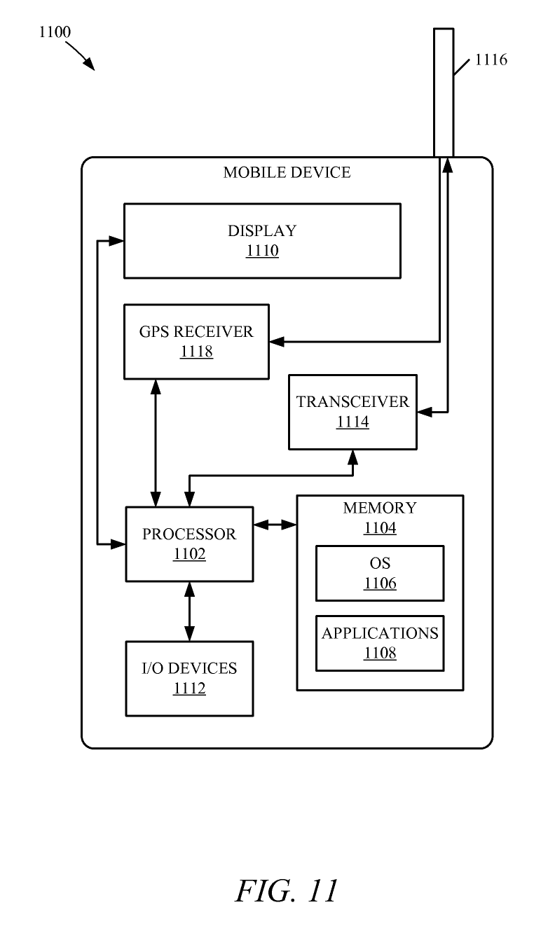

FIG. 11 is a block diagram illustrating a mobile device 1100, according to an example embodiment. The mobile device 1100 may include a processor 1102. The processor 1102 may be any of a variety of different types of commercially available processors 1102 suitable for mobile devices 1100 (for example, an XScale architecture microprocessor, a microprocessor without interlocked pipeline stages (MIPS) architecture processor, or another type of processor 1102). A memory 1104, such as a random access memory (RAM), a flash memory, or other type of memory, is typically accessible to the processor 1102. The memory 1104 may be adapted to store an operating system (OS) 1106, as well as application programs 1108, such as a mobile location enabled application that may provide LBSs to a user. The processor 1102 may be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 may be coupled to a transceiver 1114 that interfaces with an antenna 1116. The transceiver 1114 may be configured to both transmit and receive cellular network signals, wireless data signals, or other types of signals via the antenna 1116, depending on the nature of the mobile device 1100. Further, in some configurations, a GPS receiver 1118 may also make use of the antenna 1116 to receive GPS signals.

Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Example Machine Architecture and Machine-Readable Medium

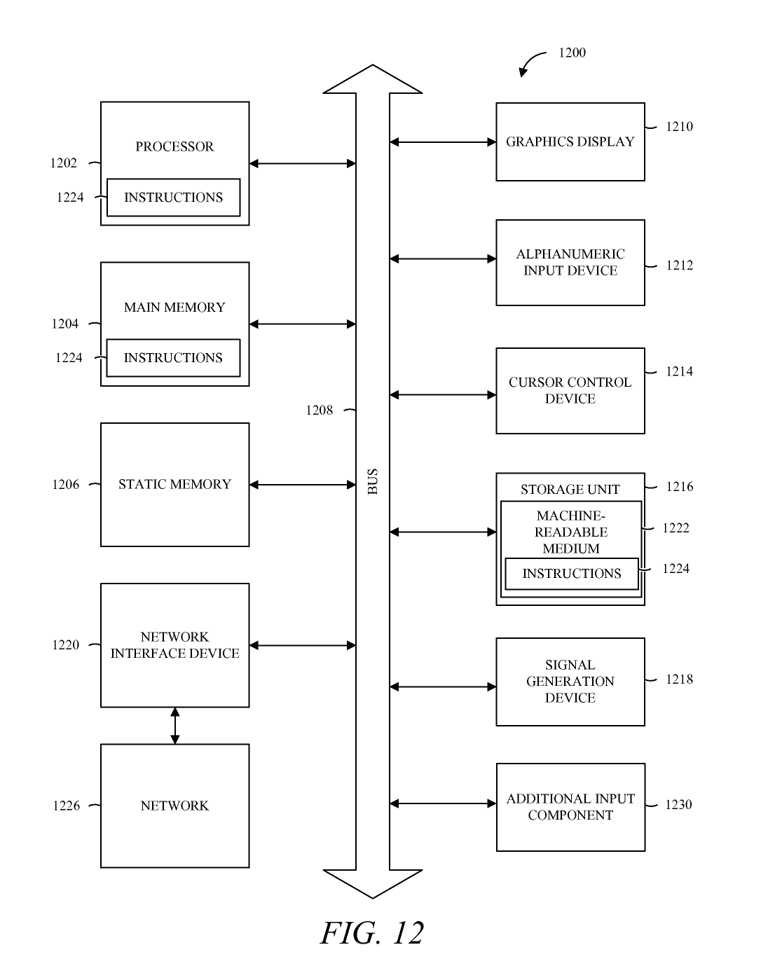

FIG. 12 is a block diagram illustrating components of a machine 1200, according to some example embodiments, able to read instructions 1224 from a machine-readable medium 1222 (e.g., a non-transitory machine-readable medium, a machine-readable storage medium, a computer-readable storage medium, or any suitable combination thereof) and perform any one or more of the methodologies discussed herein, in whole or in part. Specifically, FIG. 12 shows the machine 1200 in the example form of a computer system (e.g., a computer) within which the instructions 1224 (e.g., software, a program, an application, an applet, an app, or other executable code) for causing the machine 1200 to perform any one or more of the methodologies discussed herein may be executed, in whole or in part.

In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include any collection of machines that individually or jointly execute the instructions 1224 to perform all or part of any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The processor 1202 may contain microcircuits that are configurable, temporarily or permanently, by some or all of the instructions 1224 such that the processor 1202 is configurable to perform any one or more of the methodologies described herein, in whole or in part. For example, a set of one or more microcircuits of the processor 1202 may be configurable to execute one or more modules (e.g., software modules) described herein.

The machine 1200 may further include a graphics display 1210 (e.g., a plasma display panel (PDP), a light emitting diode (LED) display, a liquid crystal display (LCD), a projector, a cathode ray tube (CRT), or any other display capable of displaying graphics or video). The machine 1200 may also include an alphanumeric input device 1212 (e.g., a keyboard or keypad), a cursor control device 1214 (e.g., a mouse, a touchpad, a trackball, a joystick, a motion sensor, an eye tracking device, or other pointing instrument), a storage unit 1216, an audio generation device 1218 (e.g., a sound card, an amplifier, a speaker, a headphone jack, or any suitable combination thereof), and a network interface device 1220.

The storage unit 1216 includes the machine-readable medium 1222 (e.g., a tangible and non-transitory machine-readable storage medium) on which are stored the instructions 1224 embodying any one or more of the methodologies or functions described herein. The instructions 1224 may also reside, completely or at least partially, within the main memory 1204, within the processor 1202 (e.g., within the processor's cache memory), or both, before or during execution thereof by the machine 1200. Accordingly, the main memory 1204 and the processor 1202 may be considered machine-readable media (e.g., tangible and non-transitory machine-readable media). The instructions 1224 may be transmitted or received over the network 1226 via the network interface device 1220. For example, the network interface device 1220 may communicate the instructions 1224 using any one or more transfer protocols (e.g., hypertext transfer protocol (HTTP)).

In some example embodiments, the machine 1200 may be a portable computing device, such as a smart phone or tablet computer, and have one or more additional input components 1230 (e.g., sensors or gauges). Examples of such input components 1230 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1224 for execution by the machine 1200, such that the instructions 1224, when executed by one or more processors of the machine 1200 (e.g., processor 1202), cause the machine 1200 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
performing an analysis of profile data associated with a plurality of members of a social network service;
identifying, using one or more hardware processors, a projected next position in a career path model, the identifying of the projected next position being based on the analysis of the profile data and a present job position of a particular member of the social network service, the present job position and the projected next position being consecutive positions included in the career path model;
identifying a cohort that includes cohort members who are other members of the social network service, the identifying of the cohort being based on each cohort member holding the projected next position in a respective career, each cohort member being associated with one or more skills;
identifying one or more over-indexed skills for the cohort based on the one or more skills of the cohort members; and
generating a recommendation that includes the one or more over-indexed skills.

2. The method of claim 1, wherein the identifying of the projected next position includes:
identifying a first tuple of employment attributes associated with the particular member, the first tuple of employment attributes indicating a present career phase of the particular member,
selecting the career path model based on the first tuple of employment attributes, and
determining a second tuple of employment attributes based on the career path model, the second tuple of employment attributes indicating the projected next position in the career path model and a likely next career phase of the particular member.

3. The method of claim 2, wherein the first tuple includes a title-seniority pair that indicates a present title of the particular member and a present seniority of the particular member.

4. The method of claim 2, wherein the first tuple includes a title-years of experience pair that indicates a present title of the particular member and a number of years of experience of the particular member.

5. The method of claim 1, wherein performing of the analysis of the profile data includes:
analyzing career progressions of the plurality of members of the social network service based on the profile data and
generating one or more career path models based on the analysis of the career progressions of the plurality of members of the social network service.

6. The method of claim 1, further comprising:
identifying the present job position of the particular member based on profile data associated with the particular member; and
identifying the career path model based on the present job position being included in the career path model.

7. The method of claim 1, wherein the career path model is a first alternative career path model, the projected next position is a first projected next position, and the cohort is a first cohort, and further comprising:
identifying a second projected next position in a second alternative career path model based on the present job position of the particular member, the present job position and the second projected next career position in the second alternative career path being consecutive positions included in the second alternative career path model,
identifying a second cohort that includes second cohort members who are further members of the social network service, the identifying of the second cohort being based on each member of the second cohort holding the second projected next position in a respective career, each member of the second cohort being associated with one or more further skills, and
identifying a number of over-indexed skills for the second cohort based on the one or more further skills of the members of the second cohort.

8. The method of claim 7, further comprising:
selecting one or more cohorts from a plurality of cohorts based on a particular probability indicating a likelihood of the particular member choosing a particular career path that corresponds to a particular cohort, and
wherein the recommendation presents the one or more over-indexed skills for the corresponding one or more selected cohorts in association with corresponding career paths.

9. The method of claim 1, wherein the identifying of the one or more over-indexed skills for the cohort includes:
identifying one or more skills that are common among the members of the cohort and not common across a plurality of cohorts, and
selecting one or more particular skills that the particular member does not possess from the one or more skills that are common among the members of the cohort and not common across a plurality of cohorts.

10. The method of claim 1, further comprising:
transmitting a communication to the particular member, the communication including the recommendation that includes the one or more over-indexed skills presented in association with a job title that corresponds to the projected next position in the career path.

11. A system comprising:
a career path module, comprising one or more hardware processors, configured to
perform an analysis of profile data associated with a plurality of members of a social network service and
identify a projected next position in a career path model, the identifying of the projected next position being based on the analysis of the profile data and a present job position of a particular member of the social network service, the present job position and the projected next position being consecutive positions included in the career path model;
a cohort module configured to identify a cohort that includes cohort members who are other members of the social network service, the identifying of the cohort being based on each cohort member holding the projected next position in a respective career, each cohort member being associated with one or more skills;
a skill analysis module configured to identify one or more over-indexed skills for the cohort based on the one or more skills of the cohort members; and
a recommendation module configured to generate a recommendation that includes the one or more over-indexed skills.

12. The system of claim 11, wherein the identifying of the projected next position includes:
identifying a first tuple of employment attributes associated with the particular member, the first tuple of employment attributes indicating a present career phase of the particular member,
selecting the career path model based on the first tuple of employment attributes, and
determining a second tuple of employment attributes based on the career path model, the second tuple of employment attributes indicating the projected next position in the career path model and a likely next career phase of the particular member.

13. The system of claim 12, wherein the first tuple includes a title-seniority pair that indicates a present title of the particular member and a present seniority of the particular member.

14. The system of claim 12, wherein the first tuple includes a title-years of experience pair that indicates a present title of the particular member and a number of years of experience of the particular member.

15. The system of claim 11, wherein performing of the analysis of the profile data includes:
analyzing career progressions of the plurality of members of the social network service based on the profile data and
generating one or more career path models based on the analysis of the career progressions of the plurality of members of the social network service.

16. The system of claim 11, wherein the career path module is further configured to:
identify the present job position of the particular member based on profile data associated with the particular member; and
identify the career path model based on the present job position being included in the career path model.

17. The system of claim 11, wherein the career path model is a first alternative career path model, the projected next position is a first projected next position, and the cohort is a first cohort, and wherein
the career path module is further configured to identify a second projected next position in a second alternative career path model based on the present job position of the particular member, the present job position and the second projected next career position in the second alternative career path being consecutive positions included in the second alternative career path model,
the cohort module is further configured to identify a second cohort that includes second cohort members who are further members of the social network service, the identifying of the second cohort being based on each member of the second cohort holding the second projected next position in a respective career, each member of the second cohort being associated with one or more further skills, and
the skill analysis module is further configured to identify a number of over-indexed skills for the second cohort based on the one or more further skills of the members of the second cohort.

18. The system of claim 17, further comprising:
a selection module configured to select one or more cohorts from a plurality of cohorts based on a particular probability indicating a likelihood of the particular member choosing a particular career path that corresponds to a particular cohort, and
wherein the recommendation presents the one or more over-indexed skills for the corresponding one or more selected cohorts in association with corresponding career paths.

19. The system of claim 11, further comprising:
a communication module configured to transmit a communication to the particular member, the communication including the recommendation that includes the one or more over-indexed skills presented in association with a job title that corresponds to the projected next position in the career path.

20. A non-transitory machine-readable medium comprising instructions that, when executed by one or more processors of a machine, cause the machine to perform operations comprising:
performing an analysis of profile data associated with a plurality of members of a social network service;
identifying, using one or more hardware processors, a projected next position in a career path model, the identifying of the projected next position being based on the analysis of the profile data and a present job position of a particular member of the social network service, the present job position and the projected next position being consecutive positions included in the career path model;
identifying a cohort that includes cohort members who are other members of the social network service, the identifying of the cohort being based on each cohort member holding the projected next position in a respective career, each cohort member being associated with one or more skills;
identifying one or more over-indexed skills for the cohort based on the one or more skills of the cohort members; and
generating a recommendation that includes the one or more over-indexed skills.
